(19) United States
(12) Patent Application Publication
(10) Pub. No.: US 2005/0184979 A1
(43) Pub. Date: Aug. 25, 2005

(54) Liquid crystal display device

(76) Inventor: Nobuhisa Sakaguchi, Tenri-shi (JP)

Correspondence Address: HARNESS, DICKEY & PIERCE, P.L.C., P.O. BOX 8910, RESTON, VA, 20195, US

(21) Appl. No.: 11/060,351

(22) Filed: Feb. 18, 2005

(30) Foreign Application Priority Data
Feb. 19, 2004 (JP) 2004-043570

(51) Int. Cl. G02F 1/136

(52) U.S. Cl. 345/204; 349/87

(57) ABSTRACT

The present invention provides a liquid crystal display device that achieves increase in operating speed of a drive circuit, reduction in load of signal source, low power consumption, and improvement in reliability of electric conduction between a liquid crystal display section and a liquid crystal driver. The liquid crystal display device includes a liquid crystal display section 44, a source driver 30 having an input latch circuit 48 and circuits 33 to 37, and 39 each of which samples gradation displaying data signal R,G, or B outputted from a control circuit 45 and holds the signal in output terminals thereof for a predetermined period. The circuits 33 to 37, and 39 are each formed of a p-Si thin film on a glass substrate 43 on which the liquid crystal display section 44 is provided. Moreover, the input latch circuit 48 is formed inside a logic circuit 41 formed on a monocrystal silicon substrate.

This Nonprovisional application claims priority under 35 U.S.C. § 119(a) on Patent Application No. 2004/43570 filed in Japan on Feb. 19, 2004, the entire contents of which are hereby incorporated by reference.

### FIELD OF THE INVENTION

The present invention relates to an active matrix liquid crystal display device such as a TFT (Thin Film Transistor) liquid crystal display device, and particularly relates to an active matrix liquid crystal display device in which at least a part of a liquid crystal drive circuit, which applies a gradation displaying analog voltage to a liquid crystal pixel, is formed on a substrate such as a glass substrate on which switching sections such as TFTs and liquid crystal are formed.

### BACKGROUND OF THE INVENTION

Conventionally, an active matrix type liquid crystal display device is generally arranged such that a liquid crystal display section including liquid crystal, switching sections, and the like is formed on a glass substrate, and a liquid crystal drive circuit for driving the liquid crystal display section is formed on a silicon substrate separated from the glass substrate, and the liquid crystal display section and the liquid crystal drive circuit are connected with wirings.

FIG. 4 illustrates a block configuration of a TFT type liquid crystal display device which is one of the typical examples of the active matrix type liquid crystal display devices. This liquid crystal display device is structured such that the liquid crystal display section and the liquid crystal drive circuit (liquid crystal drive section) are separated from each other. The liquid crystal display section includes a TFT type liquid crystal panel 1. In the liquid crystal panel 1, liquid crystal display elements (not illustrated) and a counter electrode (common electrode) 2 described later are provided.

Meanwhile, the liquid crystal drive circuit includes a source driver 3 and a gate driver 4 each of which is formed from an IC (integrated circuit), a controller 5, and a liquid crystal drive power source 6. The controller 5 inputs display data signal D and a control signal S1 to the source driver 3, and inputs a vertical synchronization signal S2 to the gate driver 4. Further, the controller 5 inputs a horizontal synchronization signal to both of the source driver 3 and the gate driver 4.

In the above arrangement, display data is externally inputted as the display data signal D, which is a digital signal, through the controller 5 to the source driver 3. The source driver 3 carries out time-division of the display data signal D thus inputted, and latches the resulting signals in the first to n-th source drivers. After that, the source driver 3 carries out D/A conversion (Digital/Analog conversion) with respect to the time-divided display data signals D, in sync with the level synchronization signal inputted from the controller 5. As a result, an analog voltage for gradation display (hereinafter referred to as a gradation displaying voltage) is obtained. Then, the source driver 3 outputs the gradation displaying voltage through a source signal line (not illustrated) of the liquid crystal display panel 1 to a corresponding liquid crystal display element of the liquid crystal panel 1.

FIG. 5 illustrates an arrangement of the liquid crystal panel 1. The liquid crystal display panel 1 includes pixel electrodes 11, pixel capacitors 12, TFTs 13 for turning ON/OFF of a voltage applied to the pixel electrodes 11, source signal lines 14, gate signal lines 15, a counter electrode 16 (corresponding to a counter electrode 2 illustrated in FIG. 4). Here, a single pixel electrode 11, a single pixel electrode capacitor 12, and a single TFT13 compose a liquid crystal display element A.

To the source signal lines 14, a gradation displaying voltage corresponding to brightness of the target pixel (for display) is given from the source driver 3 illustrated in FIG. 4. Meanwhile, to the gate signal lines 15, scanning signals for sequentially turning on the TFTs 13 lined up in a column direction are given from the gate driver 4. Then, the gradation displaying voltage is applied from the source signal lines 14 through the TFTs 13 in an ON state to the pixel electrodes 11 connected to drain electrodes of the TFTs 13, so that the pixel capacitors 12 provided between the pixel electrodes 11 and the counter electrode 16 is charged. Therefore, optical transmittance of the liquid crystal provided between the pixel electrodes 11 and the counter electrode 16 changes in response to the gradation displaying voltage, so that the gradation display of the pixels is carried out.

Each of FIG. 6 and FIG. 7 illustrates an example of a waveform of a liquid crystal driving voltage. In FIG. 6 and FIG. 7, each of reference numerals 21 and 25 indicates a waveform of the gradation displaying voltage given from the source driver 3 to the source signal lines 14, and each of reference numerals 22 and 26 indicates a waveform of the scanning signal given from the gate driver 4 to the gate signal lines 15. Moreover, in FIG. 6 and FIG. 7, each of reference numerals 23 and 27 indicates an electric potential of the counter electrode 16, and each of reference numerals 24 and 28 indicates a waveform of a voltage applied to the pixel electrodes. Here, a voltage applied to the liquid crystal is an electric potential difference between the pixel electrodes 11 and the counter electrode 16, and the voltage is illustrated in FIGS. 6 and 7 with diagonal lines.

For example, in the case of FIG. 6, TFTs 13 turn on only in a period when a level of the scanning signal 22 outputted from the gate driver 4 is “H”, and a voltage, which is a voltage of difference between the gradation displaying voltage 21 from the source driver 3 and the potential 23 of the counter electrode 16, is applied to the liquid crystal (pixel capacitors 12). After that, the level of the scanning signal 22 outputted from the gate driver 4 becomes “L”, and TFTs 13 turns to OFF state. Then, because of the existence of the pixel capacitors 12 in the pixels, the above-described voltage is maintained.

The structure of FIG. 7 is substantially the same as that of FIG. 6, however, FIG. 6 and FIG. 7 use different voltages to be applied to the liquid crystals, specifically, the voltage applied to the liquid crystal is higher in FIG. 6 than that in FIG. 7. By analogically changing the voltage applied to the liquid crystal, optical transmittance of the liquid crystal is analogically changed, thereby carrying out multiple-gradation display. Note that, the number of displayable gradation levels depends on the number of choices of the analog voltage applied to the liquid crystal.

FIG. 8 is a block diagram illustrating one example of n-th source driver in the source driver 3 illustrated in FIG. 4. Display data D, which is an input digital signal, has an R (red) display data DR, a G (green) display data DG, and a B (blue) display data DB. The display data D is first temporarily latched in the input latch circuit 31, and then time-divided and stored in a sampling memory circuit 33 in synchronism with the operation of the shift register circuit 32, which operation is controlled by a start pulse SP and a clock signal CK outputted from the controller 5 illustrated in FIG. 4. After that, all items of the display data stored in the sampling memory circuit 33 are transferred to a hold memory circuit 34 at the same time in response to the level synchronization signal (not illustrated) outputted from the controller 5. Note that, from the shift register circuit 32, a cascade output signal S is outputted to the next shift register.

A reference voltage generating circuit 39 generates gradation displaying reference voltages of various levels according to voltages VR supplied from an outer reference voltage generating circuit (corresponding to a liquid crystal driving power source 6 illustrated in FIG. 4). The data of the hold memory circuit 34 is transferred through the level shifter circuit 35 to a D/A converting circuit (digital-analog converting circuit) 36, and the D/A converting circuit 36 converts the data into analog voltages according to each of the reference voltages of various levels outputted from the reference voltage generating circuit 39. Each analog voltage thus produced is outputted as the gradation displaying voltage from an outputting circuit 37 through a liquid crystal driving voltage output terminal 38 to a source signal line 14 of each liquid crystal display element A in FIG. 5.

However, in a general conventional active matrix type liquid crystal display device, a larger number of pixels requires a larger number of wires for connecting the liquid crystal display section with the liquid crystal drive circuit, meaning that the number of output terminals of the liquid crystal drive circuit and the number of input terminals of the liquid crystal display section are also increased. This causes a difficulty in connecting the liquid crystal display section with the liquid crystal drive circuit.

That is, a single liquid crystal driving voltage output terminal 38 corresponds to a single source signal line 14, and therefore, when there are, for example, one hundred source signal lines 14, one hundred liquid crystal driving voltage output terminals are required. Especially, a color liquid crystal display device requires one source signal line 14 for each of R (red) pixels, G (green) pixels, and B (blue) pixels, and therefore, three source signal lines 14 drive one line of a screen (one line of the display data). On this account, in the above-described example, the number of output terminals is tripled, that is, three hundred liquid crystal driving voltage output terminals are required.

As described above, in order to increase the number of pixels in the liquid crystal display device, it is necessary to increase the number of liquid crystal driving voltage output terminals 38 of the source driver 3 for driving the liquid crystal display section according to the number of increased pixels. This causes a difficulty in connecting the liquid crystal display section with the liquid crystal drive circuit.

In order to solve the above-described problem, Document 1 and Document 2 disclose a method of reducing the number of driving voltage output terminals of the liquid crystal drive circuit, which method drives several source signal lines in the liquid crystal panel by a single driving voltage output terminal of the liquid crystal drive circuit by a time-divisional manner. In this method, a TFT, which is used for a TFT liquid crystal panel, is also used as a selecting switch for selecting one of the plural source signal lines, thereby driving a plurality of source signal lines by a single driving voltage output terminal.

Moreover, as another method for overcoming the problem above, an arrangement in which the liquid crystal display section and the liquid crystal drive circuit are formed on a single glass substrate is disclosed. For example, Document 3 discloses such an arrangement that the liquid crystal display section, the liquid crystal drive circuit including a vertical drive circuit and a level drive circuit, and peripheral circuits such as a timing generating circuit are simultaneously fabricated on a single glass substrate. As a method of forming an element composing the liquid crystal drive circuit on the glass substrate, which method is not disclosed in Document 3, a method of forming a silicon thin film on the glass substrate is used. The formation of the silicon thin film on the glass substrate is performed by, for example, a method of forming a p-Si (polysilicon) film by forming an a-Si (amorphous silicon) film on the glass substrate 43 by a plasma chemical vapor deposition, and melting the a-Si film with high-power-laser irradiation so as to solidify the a-Si film.

According to the above arrangement, all the liquid crystal drive circuits are formed on the glass substrate. Therefore, even when the number of pixels is increased, thus increasing the number of source signal lines and the number of gate signal lines are increased, there is no difficulty in connecting the liquid crystal display section with the liquid crystal driver.

However, in the drive methods disclosed in Document 1 and Document 2, if the number of pixels is increased to a further greater value, as well as the number of source signal lines and the number of gate signal lines, there again occurs the problem of difficulty in connecting the liquid crystal display section with the liquid crystal driver.

Meanwhile, when all the drive circuits are formed on the glass substrate as disclosed in Document 3, the following problem occurs.

In a semiconductor device (LSI) formed on a single crystal silicon substrate, electron mobility is 1,500 cm²/V·s. Meanwhile, in a silicon thin film formed on the glass substrate, electron mobility is from 0.5 cm²/V·s to 1 cm²/V·s when the silicon thin film is made of a-Si, and electron mobility is from 100 cm²/V·s to 400 cm²/V·s when the silicon thin film is made of p-Si (see Non-patent Document 1). On this account, the liquid crystal drive circuit formed on the glass substrate is slower in operating speed, and therefore, lower in driving ability than the liquid crystal drive circuit (LSI) formed on the silicon substrate. Such decrease in operating speed of the liquid crystal drive circuit results in incapability of processing of data signals at a predetermined sampling speed. Moreover, when the driving ability of the liquid crystal drive circuit is low, it is necessary to increase the output voltage of a signal source so as to supply a driving voltage of the liquid crystal to the liquid crystal display section. Therefore, the load of the signal source increases.

Moreover, in the case of the liquid crystal drive circuit (LSI) formed on the silicon substrate, the liquid crystal can be driven by a driving voltage from 3.3V to 5V. Meanwhile, in the case of the liquid crystal drive circuit, which is made of a semiconductor thin film such as a p-Si thin film, formed on the glass substrate, it is necessary to output a driving voltage from 8V to 12V to drive the liquid crystal. Therefore, electric power consumption is increased (see Non-patent Document 2).

In the structure disclosed in Document 3, these problems are ineludible in forming all the drive circuits on the glass substrate. Therefore, in the invention disclosed in Document 3, the problem of increase of the number of above-mentioned liquid crystal driving voltage output terminals of the source driver is not fully solved.

[DOCUMENT 1]

Japanese Laid-Open Patent Application 1986/223791 (Tokukaisho 61-223791, published on Oct. 4, 1986)

[DOCUMENT 2]

Japanese Laid-Open Patent Application 1994/138851 (Tokukaihei 6-138851, published on May 20, 1994)

[DOCUMENT 3]

Japanese Laid-Open Patent Application 2002/175026 (Tokukai 2002-175026, published on Jun. 21, 2002)

[NON-PATENT DOCUMENT 1]

Masayuki Abe, Masahiro Okabe, “Polysilicon TFT Liquid Crystal Display”, [online], 1997, FUJITSU LABORATORIES LTD., [Searched on Jan. 15, 2004], Internet<URL: http://magazine.fujitsu.com/vol48-3/7-2.html>

[NON-PATENT DOCUMENT 2]

Kenji Saito, “Mobile: What is the real merit of low-temperature polysilicon TFT?”, [online], on Jul. 4, 2003, SOFTBANK ITMEDIA, INC., [Searched on Jan. 15, 2004], Internet<URL: http://www.itmedia.co.jp/mobile/0307/04/n_{—}1tpn.html>

### SUMMARY OF THE INVENTION

The present invention was made to solve the above problems, and an object of the present invention is to provide a liquid crystal display device that achieves increase in operating speed of a drive circuit, reduction in load of signal source, low power consumption, and improvement in reliability of electric conduction between a liquid crystal display section and a liquid crystal driver.

In order to solve the above-described problems, the liquid crystal display device of the present invention includes (i) a liquid crystal display section including liquid crystal pixels and switching sections for turning ON/OFF application of voltage to the liquid crystal pixels, and (ii) a drive circuit for generating, based on a signal group including a gradation displaying data signal supplied from an external control circuit, a gradation displaying analog voltage supplied to the switching sections so as to apply the gradation displaying analog voltage to the liquid crystal pixels, the drive circuit including (i) an input latch circuit for sampling the gradation displaying data signal from the external control circuit and holding the gradation displaying data signal in an output terminal thereof for a predetermined period, and (ii) a gradation displaying voltage generating circuit for generating the gradation displaying analog voltage based on the gradation displaying data signal sampled by the input latch circuit, the gradation displaying voltage generating circuit being formed of a first semiconducting material on a substrate on which the liquid crystal display section is provided, and the input latch circuit being formed inside a logic circuit formed of a second semiconducting material different from the first semiconducting material.

According to the above arrangement, the gradation displaying voltage generating circuit is formed of a thin film made from the first semiconducting material on the substrate on which the liquid crystal display section is formed. This structure is immune to the above-mentioned problem which occurs when connecting the gradation displaying voltage generating circuit and the liquid crystal display section.

A gradation displaying analog voltage is required for each (or several) signal line(s) of the liquid crystal display section. Therefore, for example, several hundred gradation displaying analog voltages are required for the liquid crystal display section. In contrast, only one gradation displaying data signal supplied from the logic circuit to the gradation displaying voltage generating circuit is required in the case of a black-and-white display, and only three gradation displaying data signals are required in the case of an RGB color display. Therefore, it is possible to decrease the number of wirings and terminals (output terminals of the logic circuit and input terminals of the gradation displaying voltage generating circuit) for connecting the circuit (logic circuit) outside the substrate with the circuit (gradation displaying voltage generating circuit) on the substrate, thereby improving reliability of electrical conduction.

Moreover, the input latch circuit is formed inside the logic circuit from the second semiconducting material different from the first semiconducting material for forming the gradation displaying voltage generating circuit. Therefore, by using the monocrystal silicon as the second semiconducting material, it is possible to increase the operating speed of the input latch circuit. This makes it possible to improve the displaying speed. Further, by using the monocrystal silicon as the second semiconducting material, it is possible to improve the driving ability of the input latch circuit. This makes it possible to reduce the electric power consumption and the load of the signal source.

One possible arrangement for solving the problem of operating speed is a structutre in which: any member (for example, a shift register) in the drive circuit except the input latch circuit is provided outside the liquid crystal panel, and the other members (for example, members other than the shift register) of the drive circuit is formed on the liquid crystal panel. However, in this case, as in the general conventional active matrix type liquid crystal display device, the number of wirings required for connecting the liquid crystal display section with the liquid crystal drive circuit is increased as the number of pixels is increased, thus also increasing the number of output terminals of the liquid crystal drive circuit and the number of input terminals of the liquid crystal display section. This causes a difficulty in connecting the liquid crystal display section with the liquid crystal drive circuit.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating an arrangement of a liquid crystal display device in accordance with one embodiment of the present invention.

FIG. 2 is a block diagram illustrating an arrangement of the liquid crystal display device in accordance with another embodiment of the present invention.

FIG. 3 is a diagram illustrating waveforms of various signals and timings for transferring data in the liquid crystal display device in accordance with another embodiment of the present invention.

FIG. 4 is a block diagram for explaining a technical background of the present invention, that illustrates the entire arrangement of a conventional TFT type liquid crystal display device.

FIG. 5 is a diagram illustrating an arrangement of a liquid crystal display section (liquid crystal panel), that is used in the liquid crystal display device of the present invention and in a conventional liquid crystal display device.

FIG. 6 is a waveform chart for explaining the technical background of the present invention, that illustrates one example of a waveform of a liquid crystal driving voltage in the conventional TFT type liquid crystal display device.

FIG. 7 is a waveform chart for explaining the technical background of the present invention, that illustrates another example of the waveform of the liquid crystal driving voltage in the conventional TFT type liquid crystal display device.

FIG. 8 is a block diagram for explaining the technical background of the present invention, that illustrates an arrangement of the n-th source driver in the conventional TFT type liquid crystal display device.

### DESCRIPTION OF THE EMBODIMENTS

### Embodiment 1

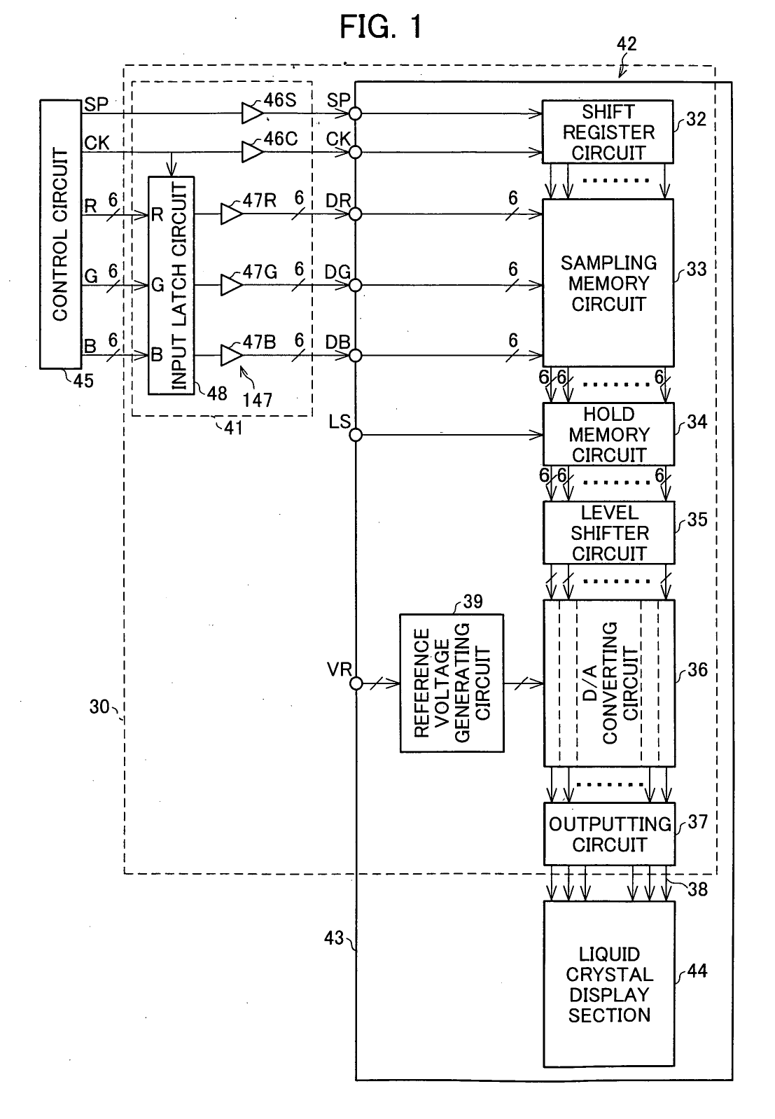

The following description explains one embodiment of the present invention in reference to the figures. FIG. 1 is a block diagram illustrating an arrangement of a TFT type liquid crystal display device as the liquid crystal display device in accordance with one embodiment of the present invention, which carries out display by driving display data by an LSI.

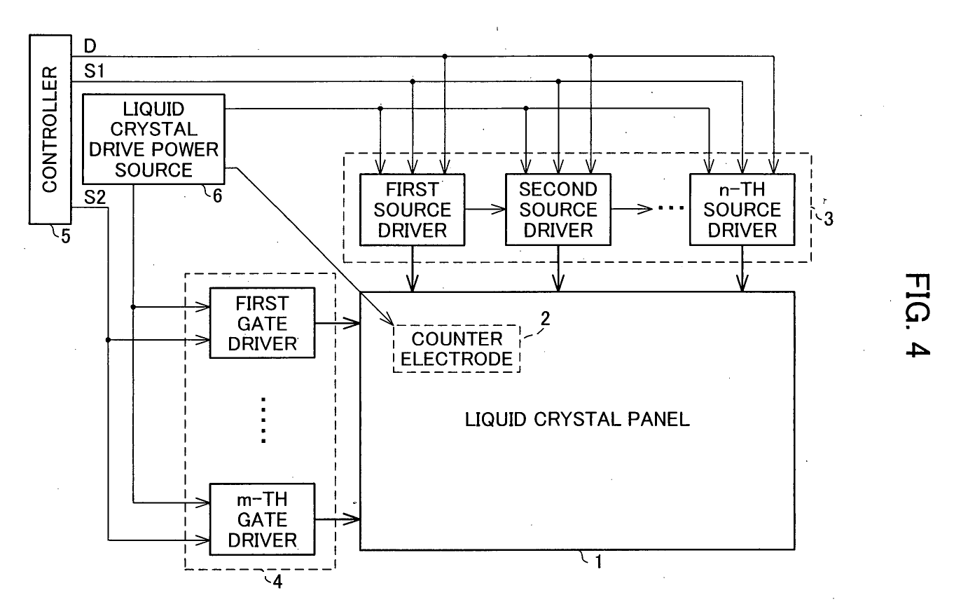

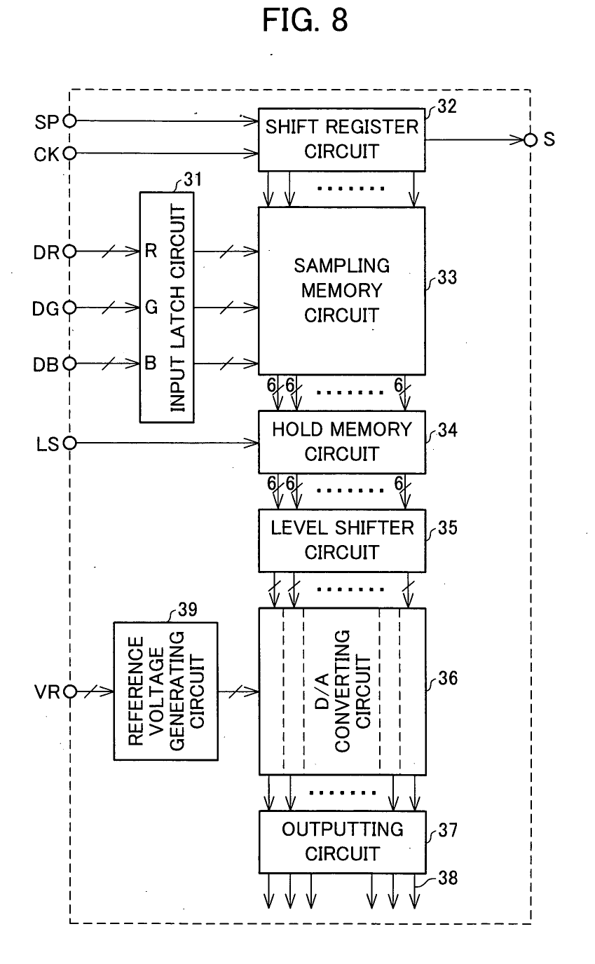

As described above, when all circuits for performing the functions of respective blocks of FIG. 8 are formed on a glass substrate, various problems occur. That is, because the input capacity of input buffer of each of the circuits on the glass substrate is large, and display data D is inputted in parallel to n source drivers as illustrated in FIG. 4, a high driving ability is required for the output section of a controller 5 outputting the display data D. Moreover, because a transfer rate from the controller 5 to the circuits on the glass substrate is high, when a data signal from the controller 5 is transferred directly to the circuits on the glass substrate, blunting and/or delay of the data signal occurs, and this causes a problem in sampling the display data. In order to solve these problems, in the liquid crystal display device in accordance with the present embodiment, an input latch circuit is not formed on the glass substrate but formed on an LSI outside the glass substrate.

The liquid crystal display device in accordance with the present embodiment includes (i) a liquid crystal display section 44 including liquid crystal pixels (not illustrated) and TFTs (not illustrated) as a switching section turning ON/OFF application of voltages to the liquid crystal pixels, and (ii) a source driver (drive circuit) 30 for generating, based on a start pulse signal SP, a clock signal CK, a red gradation displaying data signal R, a green gradation displaying data signal G, a blue gradation displaying data signal B, and a level synchronization signal (latch signal) from a control circuit 45 provided outside, a gradation displaying analog voltage supplied to source signal lines (to the TFTs) of the liquid crystal display section 44 so as to apply the gradation displaying analog voltage to the respective liquid crystal pixels. Further, the control circuit 45 is provided outside the liquid crystal display device so as to generate the start pulse signal SP, the clock signal CK, gradation displaying data signals R, G, and B, the level synchronization signal (latch signal), etc.

Moreover, the source driver 30 includes (i) a logic circuit 41 including an input latch circuit 48 which samples the gradation displaying data signals R, G, and B supplied from the control circuit 45, and holds these signals at output terminals for a predetermined period, and (ii) a gradation displaying voltage generating circuit (described later) for generating the gradation displaying analog signals according to gradation displaying data signals DR, DG, and DB generated by the sampling of the input latch circuit 48.

The above-described gradation displaying voltage generating circuit is composed of a plurality of elements (not illustrated) including an element (for example, a thin film transistor) made of a p-Si silicon thin film, and is formed on a glass substrate (substrate) 43 on which the liquid crystal display section 44 is provided. The gradation displaying voltage generating circuit, the liquid crystal display section 44, and the glass substrate 43 compose a liquid crystal display panel 42. Note that, a semiconductor thin film for forming the foregoing elements can be fabricated by a method of, for example, forming an a-Si film on the glass substrate 43 by a plasma chemical vapor deposition, melting the a-Si film with high-power-laser irradiation, and solidifying the a-Si film.

Meanwhile, the input latch circuit 48 is formed inside the logic circuit 41, which is the LSI provided outside the glass substrate 43 as a separate circuit, and the logic circuit 41 is formed on a monocrystal silicon substrate.

Note that, the above-described gradation displaying voltage generating circuit may be formed of a semiconducting material other than p-Si silicon such as a thin film made of a-Si silicon. Moreover, the logic circuit 41 is formed from the semiconducting material (second semiconducting material) different from the semiconducting material (first semiconducting material) of the gradation displaying voltage generating circuit.

Next, the following description will more specifically explain the logic circuit 41. As described above, the logic circuit 41 includes the input latch circuit 48 which is a part of the source driver 30. The control circuit 45 supplies to the input latch circuit 48 the clock signal CK and the start pulse signal SP which is a sign of a start of a data sampling, as well as the gradation displaying data signals R, G, and B, each of which is a six-bit digital signal. The input latch circuit 48 has a function of sampling the gradation displaying data signals R, G, and B in sync with the clock signal CK (for example, at a timing of a rise of the clock signal CK), and maintaining the extracted data until the timing of the next clock signal CK (for example, until a timing of a rise of the next clock signal CK).

The logic circuit 41 further includes (i) driving buffers (amplifiers, first buffer circuits) 47R, 47G, and 47B which respectively amplify the gradation displaying data signals DR, DG, and DB outputted from the input latch circuit 48 and output those to the gradation displaying voltage generating circuit, and (ii) driving buffers (amplifiers, second buffer circuits) 46S and 46C which respectively amplify the start pulse signal SP and the clock signal CK and output those to the gradation displaying voltage generating circuit. The driving buffers 47R, 47G, and 47B may be hereinafter described as one group, called a driving buffer 147. Each of the driving buffers 47R, 47G, 47B, 46S, and 46C has an ability to sufficiently amplify the signal (the gradation displaying data signal DR, DG, or DB, the start pulse signal SP, or the clock signal CK), thereby preventing generation of delay and/or blunting of the signal inputted to the gradation displaying voltage generating circuit. As described above, the logic circuit 41 includes the driving buffers 47R, 47G, 47B, 46C, and 46S each of which amplifies the signal inputted to the gradation displaying voltage generating circuit. Therefore, regardless of resistances of wirings connecting the logic circuit 41 with the liquid crystal display panel 42 (resistance of wiring for mounting the logic circuit 41 on the liquid crystal display panel 42) and input capacity of the liquid crystal display panel 42 (input capacity of the gradation displaying voltage generating circuit), it is possible to suppress the generation of the delay and/or bluntness of the signals (the gradation displaying data signals DR, DG, and DB, the start pulse signal SP, and the clock signal CK) inputted to the gradation displaying voltage generating circuit. On this account, it is not necessary to take the resistances of the wirings and the input capacity into account.

The logic circuit 41 and the liquid crystal display panel 42 are connected by, for example, (i) a COG (Chip On Glass) packaging in which the logic circuit 41 and the liquid crystal display panel 42 are connected by wirings provided on the glass substrate 43, (ii) a method in which output terminals of the logic circuit 41 and input terminals (connecting sections) of the liquid crystal display panel 42 are connected with each other by tape carriers, which are made of tape-type base materials on which conductive wires are formed.

Note that, this structure includes a gate driver (not illustrated) for driving the gate signal lines of the liquid crystal display section 44 in response to a gate pulse signal outputted from the control circuit 45, so as to control writing of the gradation displaying voltage to each of the liquid crystal pixels. The gate driver is provided inside or outside the liquid crystal display device.

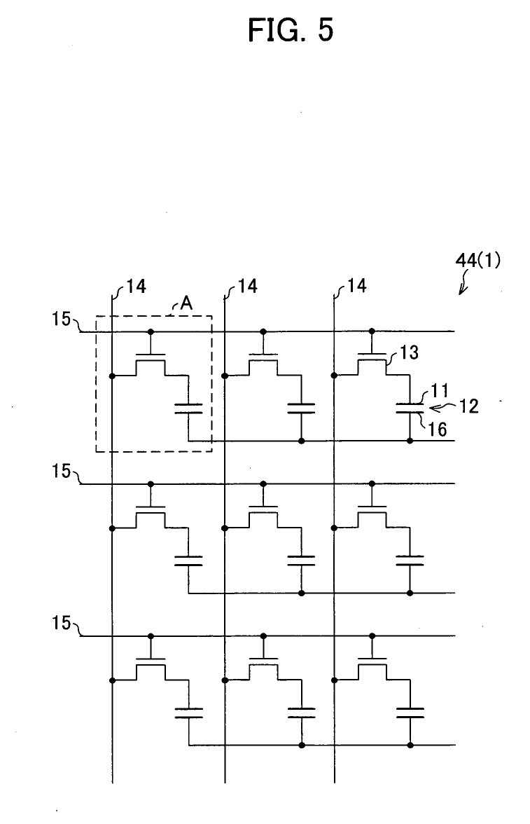

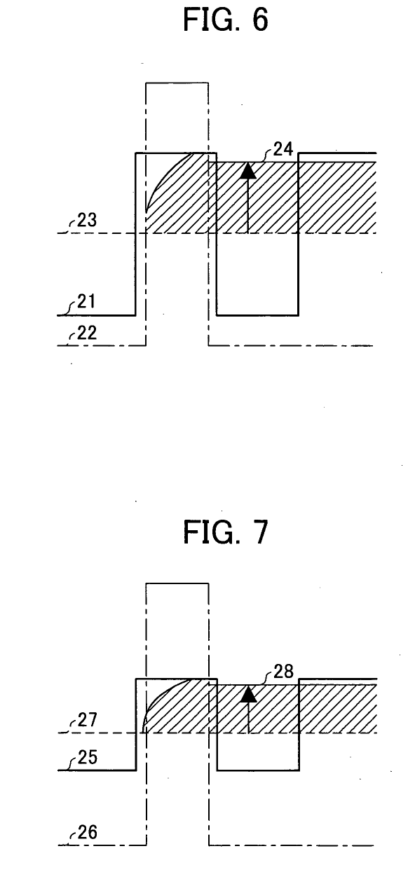

As illustrated in FIG. 5, the liquid crystal display section 44 includes (i) pixel capacitors (liquid crystal pixels) 12 made of liquid crystal, (ii) pixel electrodes 11 for generating an electric field between both ends of each of the pixel capacitors 12 (between both surfaces of a liquid crystal layer), (iii) TFTs 13 as a switching section for turning ON/OFF application of a voltage applied to the pixel electrodes 11 (application of electric field to the pixel capacitors 12), (iv) source signal lines 14 for supplying the gradation displaying voltages (source signals) to drain electrodes of the TFTs 13, (v) gate signal lines 15 for supplying gate signals to gate electrodes of TFTs 13, and (vi) a single counter electrode (not illustrated, corresponding to a counter electrode 2 in FIG. 4) opposite to the pixel electrodes 11. Here, a single pixel electrode 11, a single pixel capacitor 12, and a single TFT 13 compose a liquid crystal display element A for a single pixel.

The source driver 30 illustrated in FIG. 1 supplies the gradation displaying analog voltage corresponding to brightness of pixels for displaying an image to the source signal lines 14. Meanwhile, the gate driver 4 supplies scanning signals for sequentially turning on the TFTs 13 lined up in a column direction to the gate signal lines 15. Then, the gradation displaying analog voltage is applied from the source driver 30 through the source signal lines 14 and TFTs 13 in an ON state to the pixel electrodes 11 connected to the drain electrodes of the TFTs 13, so that the pixel capacitors 12 provided between the pixel electrodes 11 and the counter electrode 16 are charged, that is, the liquid crystal are charged. Therefore, optical transmittance of the liquid crystal provided between the pixel electrodes 11 and the counter electrode 16 changes in response to the gradation displaying analog voltage, so that the gradation display of the pixels is carried out.

The following description mainly explains the source driver 30 which is a gradation displaying voltage generating device of the present invention.

As can be seen in FIG. 1 illustrating a schematic circuit arrangement of the source driver 30, the source driver 30 includes, in addition to the above-described input latch circuit 48, a shift register 32, a sampling memory circuit 33, a hold memory circuit 34, a level shifter circuit 35, a reference voltage generating circuit 39, a D/A converting circuit 36, and an outputting circuit 37, as the gradation displaying voltage generating circuit for generating the gradation displaying analog voltage.

The shift register circuit 32 is driven by the logic circuit 41, and carries out shifting operation in response to the start pulse signal SP and the clock signal CK. The start pulse signal SP transferred from the logic circuit 41 is synchronized with the clock signal CK, and is transferred to the respective stages in the shift register circuit 32, and is outputted from the final stage of the shift register circuit 32 to the next-stage source driver as a cascade output signal (start pulse signal SP of the next-stage source driver).

The gradation display data signals DR, DG, and DB inputted from the input latch circuit 48 to the liquid crystal display panel 42 are temporarily stored in the sampling memory circuit 33 by a time-divisional manner in conformity with the operation of the shift register circuit 32, that is, in sync with the output signal from the shift register circuit 32. Then, the gradation display data signals DR, DG, and DB are transferred to the hold memory circuit 34 all at once according to the level synchronization signal (not illustrated) from the control circuit 45.

When display data for a horizontal synchronization period is stored in the sampling memory circuit 33, the hold memory circuit 34 fetches an output signal from the sampling memory circuit 33 according to a horizontal synchronization signal (latch signal) supplied from the control circuit 45, and outputs the signal to the level shifter circuit 35, and maintains the display data until a next level synchronization signal LS is inputted.

The level shifter circuit 35 is a circuit for changing a signal level of an output signal from the hold memory circuit 34 by boosting or the like, in order to process the signal to be compatible with the D/A converting circuit 36 in the following stage which adjusts the level of the voltage applied to the liquid crystal panel. The reference voltage generating circuit 39 generates plural different analog voltages according to a plurality of reference voltages VR from a power source (not illustrated), and outputs the analog voltages to the D/A converting circuit 36.

The reference voltage generating circuit 39 generates the analog reference voltages of various levels according to the voltages (VR) supplied from an outer reference voltage generating circuit (corresponding to a liquid crystal driving power source 6 illustrated in FIG. 4). The D/A converting circuit 36 converts the display data signal into the analog voltage according to the analog reference voltages of various levels supplied from the reference voltage generating circuit 39. That is, the D/A converting circuit 36 selects one of the analog reference voltages of various levels supplied from the reference voltage generating circuit 39, corresponding to the display data signal whose level is changed by the level shifter circuit 35. The analog reference voltage expressing the gradation of the display is outputted as the gradation displaying analog voltage from each of the liquid crystal driving voltage outputting terminals 38 to each of the source signal lines of the liquid crystal display section 44 (source signal line 14 of each of the liquid crystal display elements A illustrated in FIG. 5) by the outputting circuit 37. The outputting circuit 37 functions as a buffer circuit, and is composed of, for example, a voltage follower circuit using a differential amplifier.

As described above, the liquid crystal display device of the present invention is a liquid crystal display device in which a drive circuit, which generates a gradation displaying voltage and supplies it to the liquid crystal pixels according to a control signal and gradation displaying data from an outer control circuit, is formed of a thin film transistor on a liquid crystal panel including liquid crystal pixels and a switching section which supplies a voltage to the liquid crystal pixels, wherein a logic circuit formed of a base material different from a base material for forming the drive circuit is provided between the drive circuit formed on the liquid crystal panel and the outer control circuit, and the logic circuit converts some of signals inputted to the drive circuit.

As described above, in the foregoing structure, a portion of a drive circuit for driving the liquid crystal panel is replaced with a logic circuit (LSI) provided outside the glass substrate in order to prevent defects of increase in load of signal system, low operating speed, etc. that occur when the portion is formed on the glass substrate. In this way, it is possible to reduce the load of signal system, thereby increasing the operating speed.

Moreover, as described above, in the liquid crystal display device of the present invention, the logic circuit includes the buffer circuit for the gradation displaying data signal and the buffer circuit for the clock signal. On this account, the blunting of the input signal upon input for operation can be overcome by amplification (driving operation) by the logic circuit (LSI). Therefore, it is possible to further suppress the generation of the blunting of signal due to the load of the wirings for connecting the control circuit with the drive circuits.

### Embodiment 2

The following description explains another embodiment of the present invention in reference to the figures. Note that, for ease of explanation, the same reference numerals are used for the members having the same functions as the members used in Embodiment 1, and further explanations thereof are omitted.

As described above, operations of the circuits formed on a glass substrate (circuits contained in the liquid crystal display panel) are slower than operations of the circuits formed on a monocrystal silicon substrate. Therefore, the circuits contained in the liquid crystal panel may fail to cope with the speed of the clock signal CK used for sampling the display data. This may result in failure of proper sampling.

In order to solve such a problem, in the liquid crystal display device in accordance with the present embodiment, a data sampling speed of the circuits contained in the liquid crystal panel is adjusted to be one half of a data sampling speed according to the clock signal supplied from the control circuit.

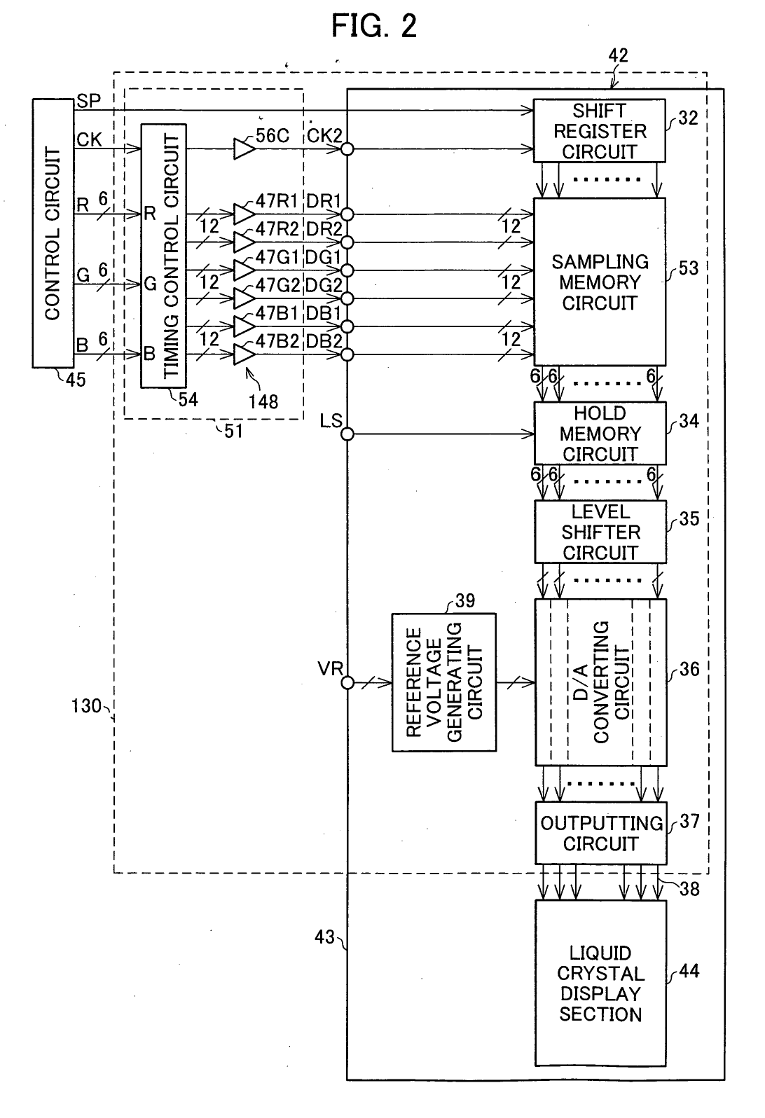

FIG. 2 is a block diagram illustrating an arrangement of a TFT type liquid crystal display device as one embodiment of the liquid crystal display device in accordance with the present invention. As illustrated in FIG. 2, the liquid crystal display device in accordance with the present embodiment includes the liquid crystal display section 44 described in Embodiment 1 and a source driver (drive circuit) 130. Further, the control circuit 45 also described in Embodiment 1 is provided outside the liquid crystal display device. The source driver 130 is arranged similarly to the source driver 30 of Embodiment 1 except that (i) the logic circuit 41, that is an external LSI formed on the monocrystal silicon substrate separated from the glass substrate 43, is replaced with a logic circuit 51, and (ii) the sampling memory circuit 33 of a six-bit input is replaced with a sampling memory circuit 53 of a twelve-bit input.

In the logic circuit 51, a timing control circuit 54 is provided. The timing control circuit 54 has not only the same functions as the functions of the input latch circuit 48 but also below-mentioned other functions. The control circuit 45 supplies the clock signal CK and the start pulse signal SP which is a sign of a start of a data sampling to the timing control circuit 54, as well as the gradation displaying data signals R, G, and B, each of which is a six-bit digital signal. The timing control circuit 54 samples the gradation displaying data signals R, G, and B according to the clock signal CK.

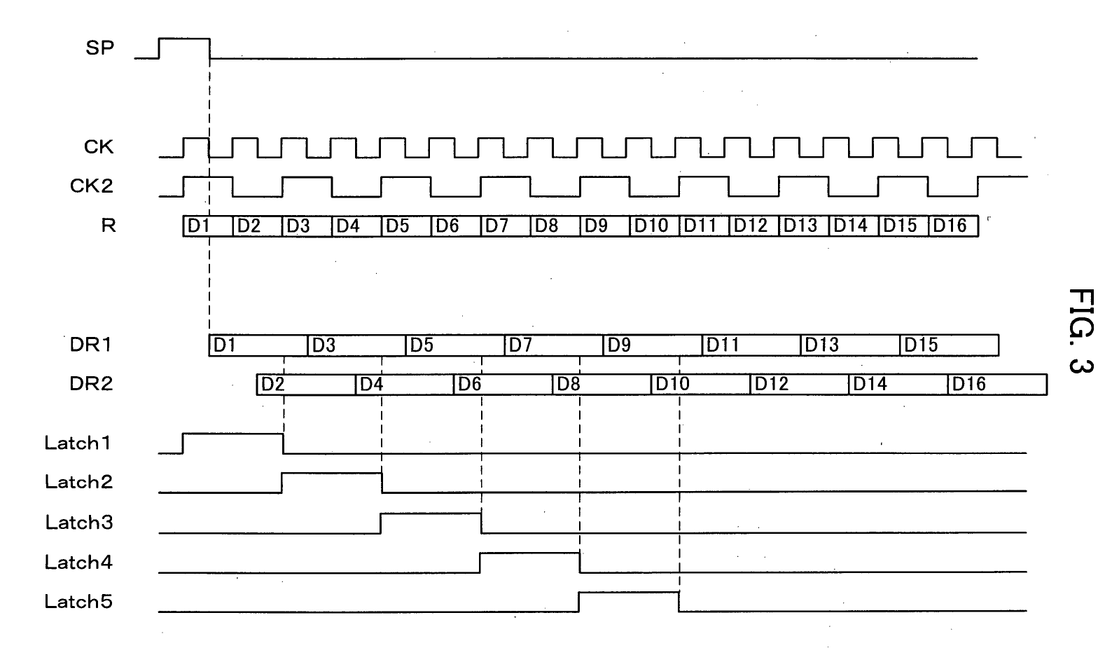

FIG. 3 illustrates timings of data sampling. The timing control circuit 54 starts data sampling, and also starts generating a clock signal CK2 which is a transfer clock of the shift register circuit 32, in sync with the start pulse signal SP.

The timing control circuit further includes a frequency divider circuit (clock signal converting circuit, not illustrated) which divides the clock signal (first clock signal) CK outputted from the control circuit 45 by two so as to generate the clock signal (second clock signal) CK2 whose frequency is one half of the frequency of the clock signal CK, and outputs the clock signal CK2 to the shift register 32.

The timing control circuit 54 further includes a data signal converting circuit which converts three gradation displaying data signals R, G, and B, outputted from the control circuit, into six gradation displaying data signals DR1, DR2, DG1, DG2, DB1, and DB2 each having a frequency of one half of the frequency of the gradation displaying data signals R, G, and B. The data signal converting circuit samples the gradation displaying data signals R, G, and B according to the clock signal CK, and converts the six-bit gradation displaying data signals R, G, and B into twelve-bit signals DR1, DR2, DG1, DG2, DB1, and DB2 as illustrated in FIG. 3. Note that, FIG. 3 illustrates only the red signals (R, DR1, and DR2), but the same manner is applied to the other colors. D1 indicates the first value (bit) of the display data serially inputted. Similarly, D2 indicates the second value, and D3 indicates the third value, . . . , and D16 indicates the sixteenth value.

The data signal converting circuit (not illustrated) can be easily realized by, for example, (i) the input latch circuit for latching the gradation displaying data signals R, G, and B in sync with a rise of the clock signal CK2, (ii) the inverter circuit for inverting the clock signal CK2 so as to generate a clock signal /CK2, and (iii) the input latch circuit for latching data (D2, D4, . . . ) in sync with a rise of the clock signal /CK2.

The gradation displaying data signals DR1, DR2, DG1, DG2, DB1, and DB2 are inputted to the liquid crystal panel 42, and are stored in the sampling memory circuit 53 by a time-divisional manner in conformity with the operation of the shift register circuit 32 which carries out shifting operation according to the clock signal CK2. Further, Latch 1, Latch 2, Latch 3, . . . illustrated in FIG. 3 are inputted to the sampling memory circuit 53 as fetching signals showing a data fetching timing, allowing the sampling memory circuit 53 to fetch the gradation displaying data signals DR1, DR2, DG1, DG2, DB1, and DB2 in sync with these fetching signals.

The clock signal CK2 here is a clock signal obtained by dividing the clock signal CK by two. That is, the frequency of the clock signal CK controlling the operations of the circuits in the liquid crystal display panel 42 (operating frequency of the circuits in the liquid crystal display panel 42) is one half of the frequency of the clock signal CK controlling the operations of the logic circuit 51 (operating frequency of the logic circuit 51). Therefore, the operating speed of the circuits in the liquid crystal display panel 42 is one half of the operating speed of the logic circuit 41. On this account, it is possible to follow the speed of the clock signal even by the circuits, whose operating speed is low, in the liquid crystal display panel 42.

Note that, operations of the hold memory circuit 34, the level shifter circuit 35, the D/A converting circuit 36, the outputting circuit 37, and the reference voltage generating circuit 39 are the same as the operations described in Embodiment 1, and explanation thereof are omitted here.

The logic circuit 51 includes (i) driving buffers 47R1, 47R2, 47G1, 47G2, 47B1, and 47B2 which respectively amplify the gradation displaying data signals DR1, DR2, DG1, DG2, DB1, and DB2 outputted from the timing control circuit 54 and output those to the sampling memory circuit 53, and (ii) a driving buffer 56C which amplifies the clock signal CK2 and outputs it to the shift register circuit 32. The driving buffers 47R1, 47R2, 47G1, 47G2, 47B1, and 47B2 may be hereinafter described as one group, called a driving buffer 148. Each of the driving buffers 47R1 47R2, 47G1, 47G2, 47B1, 47B2, and 56C has an ability to sufficiently amplify the signal (the gradation displaying data signal DR1, DR2 DG1, DG2, DB1 or DB2, or the clock signal CK2) to prevent generation of delay and/or blunting of the signal inputted to the sampling memory circuit 53 or the shift register circuit 32. As described above, the logic circuit 51 includes the driving buffers 47R1, 47R2, 47G1, 47G2 47B1, 47B2, and 56C which respectively amplify the signals inputted to the sampling memory circuit 53 or the shift register 32. Therefore, regardless of resistances of wirings connecting the logic circuit 51 with the liquid crystal display panel 42 and input capacity of the liquid crystal display panel 42, it is possible to suppress the generation of the delay and the blunting of the signals inputted to the shift register circuit 32 and the sampling memory circuit 53. On this account, it is not necessary to take the resistances of the wirings and the input capacity into account.

Moreover, among the signals inputted to the liquid crystal display panel 42, the clock signal CK and the gradation displaying data signals DR, DG, and DB are high-speed signals, and therefore easily become blunt in waveforms. On this account, among the signals inputted to the liquid crystal display panel 42, only the clock signal CK and the gradation displaying data signals DR, DG, and DB, are amplified in the logic circuit 51. This increases operation speed, thus more easily realizing a large display screen, and high-definition.

Particularly, in an arrangement of FIG. 4 in which the gradation displaying data D is inputted to each of input terminals of n source drivers in parallel, suppression of the generation of blunting of waveforms of clock signal CK and the gradation displaying data signals DR, DG, and DB brings a great effect of suppressing an increase of the load of the signal system.

The logic circuit 51 and the liquid crystal display panel 42 are connected by (i) the COG (Chip On Glass) packaging in which the logic circuit 51 and the liquid crystal display panel 42 are connected by the wirings provided on the glass substrate 43, or (ii) a method in which output terminals of the logic circuit 51 and the input terminals (connecting sections) of the liquid crystal display panel 42 are connected with each other by the tape carriers, which are made of a tape-type base material on which conductive wires are formed. On this account, it is possible to use the existing control circuit LSI as the control circuit 45.

As described above, in the present embodiment, in order to enable the clock signal and the gradation displaying data signals to deal with the operating speed of the liquid crystal display panel 42, the clock signal is divided by two and the number of gradation displaying data signals (the number of bits, the number of data items) is doubled. More specifically, as for the operating speed, even though high speed sampling is indispensable for the sampling memory circuit 53 when performing display by liquid crystal, the sampling speed of the sampling memory circuit 53 is decreased to a level compatible with the circuits on the glass substrate 43. This decrease in sampling speed is compensated by converting the gradation displaying data signals in the logic circuit 51 (LSI) provided outside the glass substrate 43 by increasing the number of gradation displaying data signals (the number of bits, the number of data items) per unit of time, which data signals are fetched to the sampling memory circuit 53 on the glass substrate 43.

The following description explains reasons why the number of gradation displaying data signals (the number of bits, the number of data items) fetched to the sampling memory circuit 53 per unit of time needs to be increased. The gradation displaying data signal is inputted to the sampling memory circuit 53 in sync with the clock signal for controlling the operations of the sampling memory circuit 53. Therefore, in the present embodiment, because the clock signal controlling the operations of the sampling memory circuit 53 is slower than that of Embodiment 1, data reading speed of the sampling memory circuit 53 decreases. Accordingly, when the speed of clock signal in the present embodiment is decreased to one half of the clock signal in Embodiment 1, it is necessary to fetch a double amount of data to the sampling memory circuit 53 per unit of time to achieve the same apparent displaying speed as that of Embodiment 1.

Note that, similarly, it is possible to further decrease the operation frequency of the circuits in the liquid crystal display panel 42 by (i) dividing the clock signal by n (n is an integer not less than 3), and (ii) multiplying the number of gradation displaying data signals (the number of the bits, the number of data items) by n.

The present invention is not limited to the embodiments described above, but may be altered within the scope of the claims. For example, in each of the embodiments, TFT is used as the switching section. However, an MIM (Metal-Insulator-Metal) element or the like may be used as the switching section. Moreover, an embodiment based on a proper combination of technical means disclosed in different embodiments is encompassed in the technical scope of the present invention.

As described above, according to the present invention, it is possible to decrease the number of wirings and terminals for connecting the circuits (driver IC, etc.) outside the substrate with the circuits on the substrate (glass substrate). As a result, reliability in electrical conduction can be improved. Moreover, the input latch circuit is formed in the logic circuit by using the second semiconducting material, that is different from the first semiconducting material, that is p-Si or a-Si, for forming the circuits on the substrate. Therefore, by using the monocrystal silicon as the second semiconducting material, it is possible to improve the operating speed and the driving ability of the input latch circuit. On these acounts, the present invention achieves increase in operating speed of the drive circuit, reduction in load of signal source, and low power consumption.

Therefore, the present invention is useful for manufacturing industries of active matrix liquid crystal display device, such as a TFT (Thin Film Transistor) liquid crystal display device, particularly to the manufacturers of active matrix liquid crystal display device with a large number of pixels.

Moreover, it is preferable that the logic circuit further include an amplifier for amplifying at least a part of the signal group supplied from the control circuit.

According to the above arrangement, by amplifying at least a part of signal group supplied from the control circuit, it is possible to suppress the generation of blunting of signals caused by the load of the wiring for connecting the control circuit with the gradation displaying voltage generating circuit. On this account, it is possible to suppress a decrease in display characteristic (for example, a decrease in displaying speed) caused by the blunting of output signals of the control circuit. Note that, in order to suppress the generation of blunting of signals caused by the load of the wirings, it is preferable to use short wirings for connecting the control circuit with the logic circuit.

It is preferable that the external control circuit output the gradation displaying data signal and a clock signal to the logic circuit, and the amplifier include a first buffer circuit for amplifying the gradation displaying data signal and a second buffer circuit for amplifying the clock signal.

According to the above arrangement, by amplifying the gradation displaying data signals in the first buffer circuit and the clock signal in the second buffer circuit, it is possible to suppress the generation of blunting of signals caused by the load of the wirings for connecting the control circuit with the gradation displaying voltage generating circuit. On this account, it is possible to suppress, for example, the decrease in display characteristic (for example, decrease of the response property) and the delay of display, that are caused by the blunting of clock signal. Note that, in order to suppress the generation of blunting of the signal caused by the load of wirings, it is preferable to use short wirings for connecting the control circuit with the logic circuit.

Moreover, the logic circuit operates in response to the first clock signal. The gradation displaying voltage generating circuit operates in response to the second clock signal. The frequency of the second clock signal may be lower than that of the first clock signal.

According to the above arrangement, by further decreasing the frequency of the second clock signal controlling the operations of the gradation displaying voltage generating circuit, it is possible to allow the gradation displaying voltage generating circuit provided on the substrate, whose operating speed is low, to process the signal from the control circuit at a predetermined operating speed corresponding to the first clock signal. Therefore, for example, it is possible to sample the gradation displaying data signal, etc. supplied from the control circuit at a predetermined sampling speed corresponding to the first clock signal, thereby preventing the delay of display, etc.

Note that, a member supplying the first clock signal and a member supplying the second clock signal may be provided in the control circuit, the logic circuit, the gradation displaying voltage generating circuit, or outside these circuits.

The external control circuit outputs the first clock signal. The logic circuit may further include a clock signal converting circuit for converting the first clock signal outputted from the external control circuit into the second clock signal whose frequency is lower than the frequency of the first clock signal, the clock signal converting circuit outputting the second clock signal to the gradation displaying voltage generating circuit.

According to the above arrangement, a source for generating the first clock signal controlling the operations of the input latch circuit may be provided in the control circuit. On this account, it is possible to simplify the arrangement, allowing use of the existing control circuit.

Note that, it is preferable that the signal converting circuit be a frequency divider circuit which divides the first clock signal in order to obtain a signal whose frequency is 1/N (N is an integer not less than 2) of the first clock signal, in terms of simplification of arrangement of the signal converting circuit.

The logic circuit may further include a data signal converting circuit for dividing the gradation displaying data signal supplied from the external control circuit into N (N is an integer not less than 2) gradation displaying data signals each of which has a 1/N sampling frequency of the gradation displaying data signal supplied from the external control circuit.

According to the above arrangement, the decrease in sampling frequency (in sampling speed) by the logic circuit allows the gradation displaying voltage generating circuit formed on the substrate, whose operating speed is low, to sample a signal at a predetermined speed corresponding to the sampling frequency of the gradation displaying data signal, thereby preventing the delay of display.

In the liquid crystal display device of the present invention, it is preferable that the logic circuit be formed on the single crystal silicon substrate by using the single crystal silicon as the second semiconducting material. With this arrangement, because the single crystal silicon substrate has higher-electron mobility than the a-Si thin film and the p-Si thin film, it is possible to increase the operating speed of input latch circuit.

Note that, it is preferable that the above-described substrate be a translucent substrate such as the glass substrate. Moreover, it is preferable to use p-Si for the first semiconducting material for forming the gradation displaying voltage generating circuit. With this arrangement, because the p-Si thin film has higher electron mobility than the a-Si thin film, it is possible to increase the operating speed and the driving ability of the gradation displaying voltage generating circuit.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A liquid crystal display device comprising:
a liquid crystal display section including liquid crystal pixels and switching sections for turning ON/OFF application of voltage to the liquid crystal pixels; and
a drive circuit for generating, based on a signal group including a gradation displaying data signal supplied from an external control circuit, a gradation displaying analog voltage supplied to the switching sections so as to apply the gradation displaying analog voltage to the liquid crystal pixels,
the drive circuit including (i) an input latch circuit for sampling the gradation displaying data signal from the external control circuit and holding the gradation displaying data signal in an output terminal thereof for a predetermined period, and (ii) a gradation displaying voltage generating circuit for generating the gradation displaying analog voltage based on the gradation displaying data signal sampled by the input latch circuit,
the gradation displaying voltage generating circuit being formed of a first semiconducting material on a substrate on which the liquid crystal display section is provided, and the input latch circuit being formed inside a logic circuit formed of a second semiconducting material different from the first semiconducting material.

2. The liquid crystal display device as set forth in claim 1, wherein the logic circuit further includes an amplifier for amplifying at least a part of the signal group supplied from the control circuit.

3. The liquid crystal display device as set forth in claim 2, wherein:
the external control circuit outputs the gradation displaying data signal and a clock signal to the logic circuit, and
the amplifier includes a first buffer circuit for amplifying the gradation displaying data signal and a second buffer circuit for amplifying the clock signal.

4. The liquid crystal display device as set forth in claim 1, wherein:
the logic circuit operates in accordance with a first clock signal,
the gradation displaying voltage generating circuit operates in accordance with a second clock signal, and
the second clock signal has a lower frequency than a frequency of the first clock signal.

5. The liquid crystal display device as set forth in claim 4, wherein:
the external control circuit outputs the first clock signal, and
the logic circuit further includes a clock signal converting circuit for converting the first clock signal outputted from the external control circuit into the second clock signal whose frequency is lower than the frequency of the first clock signal, the clock signal converting circuit outputting the second clock signal to the gradation displaying voltage generating circuit.

6. The liquid crystal display device as set forth in claim 1, wherein the logic circuit further includes a data signal converting circuit for dividing the gradation displaying data signal supplied from the external control circuit into N (N being an integer not less than 2) gradation displaying data signals each of which has a 1/N sampling frequency of the gradation displaying data signal supplied from the external control circuit.
